(19) United States
(12) Patent Application Publication
(10) Pub. No.: US 2009/0137444 A1
(43) Pub. Date: May 28, 2009

(54) Laundry Detergent Acting on Cotton and Comprising Soil-Releasing Cellulose Derivative

(75) Inventors: Josef Penninger, Hilden (DE); Nadine Warkotsch, Duesseldorf (DE)

Correspondence Address: Ratner Prestia, P.O. Box 980, Valley Forge, PA, 19482, US

(73) Assignee: Henkel AG & Co. KGaA, Duesseldorf (DE)

(21) Appl. No.: 12/363,816

(22) Filed: Feb. 2, 2009

Related U.S. Application Data
(63) Continuation of application No. PCT/EP2007/056339, filed on Jun. 26, 2007.

(30) Foreign Application Priority Data
Aug. 25, 2006 (DE) 10 2006 039 873.4

(51) Int. Cl. C11D 3/22

(52) U.S. Cl. 510/283

(57) ABSTRACT

A method of improving the cleaning performance of laundry detergents when washing textiles that are made of or contain cotton by contacting the textile with a cellulose derivative that contains, on average, 0.4 to 2.7 alkyl groups and 0.001 to 0.3 carboxyalkyl groups per anhydroglycose monomer unit.

### CROSS-REFERENCE TO RELATED APPLICATIONS

This application is a continuation under 35 U.S.C. §§ 120 and 365(c) of International Application PCT/EP2007/056339, filed on Jun. 26, 2007. This application also claims priority under 35 U.S.C. § 119 of DE 10 2006 039 873.4, filed on Aug. 25, 2006. The disclosures of PCT/EP2007/056339 and DE 10 2006 039 873.4 are incorporated herein by reference in their entirety.

### BACKGROUND OF THE INVENTION

The present invention relates to the use of certain soil-release-enabling cellulose derivatives to intensify the cleaning performance of bleaching-agent-containing laundry detergents when washing textiles, especially those that are made of or contain cotton; and to bleaching-agent-containing laundry detergents and cleaning agents that contain such soil-release-enabling cellulose derivatives.

Laundry detergents generally contain, in addition to the ingredients such as surfactants and builder materials that are indispensable for the washing process, further constituents that can be grouped under the heading of “washing adjuvants” and encompass such different groups of active substances as foam regulators, graying inhibitors, bleaching agents, bleach activators, and color transfer inhibitors. Also included among such adjuvants are substances that impart soil-repelling properties to the laundry fibers and that, if present during the washing operation, assist the soil-releasing capability of the other laundry-detergent constituents. The same also applies analogously to cleaning agents for hard surfaces. Soil-release-enabling substances of this kind are often referred to as “soil release” active substances or, because of their ability to make the treated surface (for example, of the fibers) soil-repellent, as “soil repellents.” For example, the soil-release-enabling action of methyl cellulose is known from U.S. Pat. No. 4,136,038. European Patent Application EP 0 213 729 discloses decreased redeposition with the use of laundry detergents that contain a combination of soap and nonionic surfactant having alkylhydroxyalkyl cellulose. European Patent Application EP 0 213 730 discloses textile treatment agents that contain cationic surfactants and nonionic cellulose ethers having HLB values from 3.1 to 3.8. U.S. Pat. No. 4,000,093 discloses laundry detergents that contain 0.1 wt % to 3 wt % alkyl cellulose, hydroxyalkyl cellulose, or alkylhydroxyalkyl cellulose as well as 5 wt % to 50 wt % surfactant, the surfactant component being made up substantially of C₁₀ to C₁₃ alkyl sulfate and up to 5 wt % C₁₄ alkyl sulfate, and less than 5 wt % alkyl sulfate having alkyl radicals of C₁₅ and higher. U.S. Pat. No. 4,174,305 discloses laundry detergents that contain 0.1 wt % to 3 wt % alkyl cellulose, hydroxyalkyl cellulose, or alkylhydroxyalkyl cellulose as well as 5 wt % to 50 wt % surfactant, the surfactant component being made up substantially of C₁₀ to C₁₂ alkylbenzenesulfonate and comprising less than 5 wt % alkylbenzenesulfonate having alkyl radicals of C₁₃ and higher. European Patent EP 0 271 312 relates to soil-release-enabling active substances, among them cellulose alkyl ethers and cellulose hydroxyalkyl ethers (with DS of 1.5 to 2.7 and molar weights from 2000 to 100,000) such as methyl cellulose and ethyl cellulose, which are to be used with peroxygen bleaching agents at a weight ratio (based on the active oxygen content of the bleaching agent) from 10:1 to 1:10. European Patent Application EP 0 634 481 relates to a laundry detergent that contains alkali percarbonate and one or more nonionic cellulose derivatives. Explicitly disclosed among the latter are only hydroxyethyl cellulose, hydroxypropyl cellulose, and methyl cellulose, and (in the context of the Examples) the methylhydroxyethyl cellulose Tylose® MH50, the hydroxypropylmethyl cellulose Methocel® F4M, and hydroxybutyl cellulose. European Patent EP 0 948 591 B1 discloses a laundry detergent in liquid or granular form that imparts, to fabrics and textiles washed therewith, textile appearance advantages such as decreased pilling and linting, color fading prevention, improved abrasion resistance, and/or enhanced softness, and that contains 1 to 80 wt % surfactant, 1 to 80 wt % organic or inorganic builders, 0.1 to 80 wt % of a hydrophobically modified nonionic cellulose ether having a molar weight from 10,000 to 2,000,000, the modification consisting in the presence of optionally oligomerized (degree of oligomerization up to 20) ethylene oxy- or 2-propylene oxyether units and of C₈ to C₂₄ alkyl substituents, and such that the alkyl substituents must be present in quantities from 0.1 to 5 wt % based on the cellulose ether material.

Because of their chemical similarity to polyester fibers, soil-release-enabling active substances that are particularly effective for textiles made of said material are copolyesters that contain dicarboxylic acid units, alkylene glycol units, and polyalkylene glycol units. Soil-release-enabling copolyesters of the aforesaid kind, and the use thereof in laundry detergents, have been known for some time.

German Application DT 16 17 141, for example, describes a washing method using polyethylene terephthalate/polyoxyethlene glycol copolymers. German Application DT 22 00 911 relates to laundry detergents that contain nonionic surfactant and a mixed polymer of polyoxyethylene glycol and polyethylene terephthalate. German Application DT 22 53 063 recites acid textile finishing agents that contain a copolymer of a dibasic carboxylic acid and an alkylene or cycloalkylene polyglycol as well as, if applicable, an alkylene or cycloalkylene glycol. Polymers of ethylene terephthalate and polyethylene oxide terephthalate in which the polyethylene glycol units have molecular weights from 750 to 5000 and the molar ratio of ethylene terephthalate to polyethylene oxide terephthalate is 50:50 to 90:10, and the use thereof in laundry detergents, are described in German Patent DE 28 57 292. Polymers, having a molecular weight of 15,000 to 50,000, of ethylene terephthalate and polyethylene oxide terephthalate, the polyethylene glycol units having molecular weights from 1000 to 10,000 and the molar ratio of ethylene terephthalate to polyethylene oxide terephthalate being 2:1 to 6:1, can be used according to German Application DE 33 24 258 in laundry detergents. European Patent EP 066 944 relates to textile treatment agents that contain a copolyester of ethylene glycol, polyethylene glycol, aromatic dicarboxylic acid, and sulfonated aromatic dicarboxylic acid at certain molar ratios. European Patent EP 185 427 discloses polyesters, end-capped with methyl or ethyl groups, having ethylene and/or propylene terephthalate and polyethylene oxide terephthalate units, and laundry detergents that contain such soil release polymers. European Patent EP 241 984 relates to a polyester that, in addition to oxyethylene groups and terephthalic acid units, also contains substituted ethylene units as well as glycerol units. European Patent EP 241 985 discloses polyesters that, in addition to oxyethylene groups and terephthalic acid units, contain 1,2-propylene, 1,2-butylene, and/or 3-methoxy-1,2-propylene groups as well as glycerol units, and are end-capped with C₁ to C₄ alkyl groups. European Patent EP 253 567 relates to soil release polymers, having a molar weight from 900 to 9000, of ethylene terephthalate and polyethylene oxide terephthalate, the polyethylene glycol units having molecular weights from 300 to 3000 and the molar ratio of ethylene terephthalate to polyethylene oxide terephthalate being 0.6 to 0.95. European Patent Application EP 272 033 discloses polyesters, at least in part end-capped with C₁₋₄ alkyl or acyl groups, having polypropylene terephthalate and polyoxyethylene terephthalate units. European Patent EP 274 907 describes sulfoethyl-end-capped terephthalate-containing soil release polyesters. In European Patent Application EP 357 280, soil release polyesters having terephthalate, alkylene glycol, and poly-C₂₋₄ glycol units are manufactured by sulfonation of unsaturated end groups. German Patent Application DE 26 55 551 describes the reaction of such polyesters with isocyanate-group-containing polymers, and the use of the polymerizates thereby manufactured to counteract the redeposition of dirt when synthetic fibers are washed. German Patent DE 28 46 984 discloses laundry detergents that contain as a soil-release-enabling polymer a reaction product of a polyester with a prepolymer that contains terminal isocyanate groups and is obtained from a diisocyanate and a hydrophilic nonionic macrodiol.

The polymers known from the extensive existing art have the disadvantage that they possess insufficient or no activity in the context of textiles that are not, or at least not predominantly, made of polyester. Many of today's textiles are, however, made of cotton or cotton-polyester mixed fabrics, so that a need exists for soil-release-enabling polymers that are more effective especially for greasy stains on such textiles. In addition, soil-release-enabling active substances of this kind not only must be stable in the presence of bleaching agents normally contained in laundry detergents, but should exhibit particularly good effectiveness specifically in such bleaching-agent-containing detergents; and it is desirable that they should in fact improve the effectiveness of the bleaching agent or at least not impair it.

### DESCRIPTION OF THE INVENTION

It has been found, surprisingly, that this object can be achieved by the use of certain low-carboxyalkylated cellulose derivatives.

The subject matter of the invention is the use of a soil-release-enabling cellulose derivative, which is obtainable by alkylation and carboxyalkylation of cellulose, to intensify the cleaning performance of laundry detergents when washing textiles that are made of or contain cotton, the cellulose derivative containing, on average, 0.4 to 2.7 alkyl groups and 0.001 to 0.3 carboxyalkyl groups per anhydroglycose monomer unit.

A further subject of the invention is a method for washing textiles, in which method a laundry detergent and a corresponding soil-release-enabling cellulose derivative that is obtainable by alkylation and carboxyalkylation of cellulose are used. This method can be performed manually or, by preference, with the aid of a usual household washing machine. It is possible in this context to use the, in particular, bleaching-agent-containing laundry detergent and the soil-release-enabling cellulose derivative simultaneously or successively. Simultaneous utilization can be carried out particularly advantageously by using a laundry detergent that contains the soil-release-enabling cellulose derivative.

The washing-performance-intensifying effect of the cellulose derivatives to be used according to the present invention is particularly pronounced with repeated use, i.e. in particular for the removal of stains from corresponding textiles that had already been washed and/or post-treated in the presence of the cellulose derivative before they acquired the stain. In conjunction with post-treatment, it should be noted that the aforesaid positive aspect can also be realized by way of a washing method in which the textile is brought into contact, after the actual washing operation that is performed with the aid of a laundry detergent that can contain an aforesaid cellulose derivative but in this case can also be free thereof, with a post-treatment agent, for example in the context of a softening step, that contains a cellulose derivative to be used according to the present invention. With this procedure as well, the washing-performance-intensifying effect of the cellulose derivatives to be used occurs at the next washing operation even when, if desired, a laundry detergent not having an aforesaid cellulose derivative is again used. This effect is much greater than one obtained with the use of a cellulose derivative having a higher degree of carboxyalkylation.

Preferred cellulose derivatives are those that are alkylated with C₁ to C₁₀ groups, in particular C₁ to C₃ groups, and additionally carry C₁ to C₁₀ carboxyalkyl groups, in particular C₁ to C₄ carboxyalkyl groups and particularly preferably C₂ to C₃ carboxyalkyl groups (in the carbon numbers indicated, the carboxy carbon atom is not counted among the carboxyalkyl groups). These can be obtained, in known fashion, by reacting cellulose with corresponding alkylating agents, for example alkyl halides or alkyl sulfates, and subsequent reaction with corresponding halogen alkylcarboxylic acids, for example chloracetic acid, 3-chloropropionic acid, and/or 4-chlorobutanoic acid. In a preferred embodiment of the invention, on average 0.5 to 2.5, in particular 1 to 2 alkyl groups, and 0.002 to 0.2, in particular 0.005 to 0.1 carboxyalkyl groups, are contained for each anhydroglycose monomer unit. The average molar weight of the cellulose derivatives used according to the present invention is by preference in the range from 10,000 D to 150,000 D, in particular from 40,000 D to 120,000 D, and particularly preferably in the range from 70,000 D to 110,000 D. Determination of the degree of polymerization and of the molecular weight of the soil-release-enabling cellulose derivative is based on determination of the intrinsic viscosity of sufficiently dilute aqueous solutions, using an Ubbelohde capillary viscosimeter (capillary 0c). With the use of a constant [H. Staudinger and F. Reinecke, “Über Molekulargewichtsbestimmung an Celluloseethern” [Determining the molecular weight of cellulose ethers], Liebigs Annalen der Chemie 535, 47 (1938)] and a correction factor [F. Rodriguez and L. A. Goettler, “The Flow of Moderately Concentrated Polymer Solutions in Water,” Transactions of the Society of Rheology VIII, 3, 17 (1964)], the degree of polymerization can be calculated therefrom, as can, with incorporation of the degrees of substitution (DS and MS), the corresponding molecular weight.

The cellulose derivatives used according to the present invention are, as indicated, easily manufactured and are unobjectionable in both environmental and toxicological terms. They result in a significantly better release of, in particular, grease and cosmetic stains on cotton or cotton-containing fabrics than is the case with the use of compounds hitherto known for this purpose. Alternatively, significant quantities of surfactants can be saved with no change in grease-release capability.

The use according to the present invention can occur in the context of a washing process in such a way that the cellulose derivative is added to a bath containing laundry detergent, or preferably the cellulose derivative is introduced into the bath as a constituent of a laundry detergent. A further subject of the invention is therefore a laundry detergent that contains an above-described cellulose derivative.

The use according to the present invention in the context of a laundry post-treatment method can correspondingly occur in such a way that the cellulose derivative is added separately to the rinse bath that is utilized, after the washing cycle accomplished using an, in particular, bleaching-agent-containing laundry detergent; or it is introduced as a constituent of the laundry post-treatment agent, in particular a softener. In the context of this aspect of the invention, the aforesaid laundry detergent can likewise contain a cellulose derivative to be used according to the present invention, but can also be free thereof.

Laundry detergents that contain a cellulose derivative to be used according to the present invention or are used together therewith or utilized in methods according to the present invention can contain all other usual constituents of such detergents that do not interact undesirably with the cellulose derivative that is essential to the invention. The cellulose derivative is incorporated into laundry detergents by preference in quantities from 0.1 wt % to 2 wt %, in particular 0.5 wt % to 1 wt %.

It has been found, surprisingly, that such cellulose derivatives having the properties indicated above positively influence the action of certain other ingredients of laundry detergents and laundry detergents; and that conversely, the action of the cotton-active soil-release cellulose derivative is additionally intensified by certain other laundry-detergent ingredients. These effects occur in particular with bleaching agents, with enzymatic active substances, in particular proteases and lipases; with water-soluble inorganic and/or organic builders, especially based on oxidized carbohydrates or polymeric polycarboxylates; with synthetic anionic surfactants of the sulfate and sulfonate type; and with color transfer inhibitors, for example vinylpyrrolidone, vinylpyridine, or vinylimidazole polymers or copolymers or corresponding polybetaines, for which reason the use of at least one of the aforesaid further ingredients together with cellulose derivatives to be used according to the present invention is preferred.

A detergent that contains a cellulose derivative to be used according to the present invention or is used together therewith, or is utilized in the method according to the present invention, contains by preference peroxygen-based bleaching agents, in particular in quantities in the range from 5 wt % to 70 wt %, as well as (if applicable) bleach activator, in particular in quantities in the range from 2 wt % to 10 wt %. The suitable bleaching agents are, by preference, the peroxygen compounds usually used in laundry detergents, such as percarboxylic acids, for example diperdodecanoic acid or phthaloylaminoperoxycaproic acid, hydrogen peroxide, alkali perborate that can be present as a tetra- or monohydrate, percarbonate, perpyrophosphate, and persilicate, which as a rule are present as alkali salts, in particular as sodium salts. Bleaching agents of this kind are present, in laundry detergents that contain a cellulose derivative used according to the present invention, by preference in quantities of up to 25 wt %, in particular up to 15 wt %, and particularly preferably from 5 wt % to 15 wt %, based in each case on the entire detergent, percarbonate being used in particular. The optionally present component of bleach activators encompasses the N- or O-acyl compounds usually utilized, for example multiply acylated alkylenediamines, in particular tetraacetylethylenediamine, acylated glycourils, in particular tetraacetyl glycouril, N-acylated hydantoins, hydrazides, triazoles, urazoles, diketopiperazines, sulfuryl amides, and cyanurates, also carboxylic acid anhydrides, in particular phthalic acid anhydride, carboxylic acid esters, in particular sodium isononanoyl phenolsulfonate, and acylated sugar derivatives, in particular pentaacetyl glucose, as well as cationic nitrile derivatives such as trimethylammonium acetonitrile salts. In order to avoid interaction with the per-compounds during storage, the bleach activators can in known fashion have been coated with encasing substances or granulated; tetraacetylethylenediamine granulated with the aid of carboxymethyl cellulose and having average particle sizes from 0.01 mm to 0.8 mm, such as can be manufactured, for example, according to the method described in European Patent EP 37 026, granulated 1,5-diacetyl-2,4-dioxohexahydro-1,3,5-triazine, such as can be manufactured according to the method described in German Patent DD 255 884, and/or trialkylammonium acetonitrile prepared in particle form according to the methods described in International Patent Applications WO 00/50553, WO 00/50556, WO 02/12425, WO 02/12426, or WO 02/26927, are particularly preferred. Such bleach activators are contained in laundry detergents by preference in quantities of up to 8 wt %, in particular from 2 wt % to 6 wt %, based in each case on the entire detergent.

In a preferred embodiment, a detergent according to the present invention, used according to the present invention, or utilized in the method according to the present invention contains nonionic surfactant, selected from fatty alkylpolyglycosides, fatty alkylpolyalkoxylates, in particular-ethoxylates and/or -propoxylates, fatty acid polyhydroxyamides and/or ethoxylation and/or propoxylation products of fatty alkyl amines, vicinal diols, fatty acid alkyl esters, and/or fatty acid amides, as well as mixtures thereof, in particular in a quantity in the range from 2 wt % to 25 wt %.

A further embodiment of such detergents encompasses the presence of synthetic anionic surfactant of the sulfate and/or sulfonate type, in particular fatty alkyl sulfate, fatty alkyl ether sulfate, sulfofatty acid ester, and/or sulfofatty acid di-salts, in particular in a quantity in the range from 2 wt % to 25 wt %. The anionic surfactant is preferably selected from the alkyl or alkenyl sulfates and/or the alkyl or alkenyl ether sulfates in which the alkyl or alkenyl group possesses 8 to 22, in particular 12 to 18 carbon atoms. These usually are not individual substances, but rather cuts or mixtures. Preferred among them are those whose proportion of compounds having longer-chain groups in the range from 16 to 18 carbon atoms is above 20 wt %.

Among the appropriate nonionic surfactants are the alkoxylates, in particular ethoxylates and/or propoxylates, of saturated or mono- to polyunsaturated linear or branched-chain alcohols having 10 to 22 carbon atoms, by preference 12 to 18 carbon atoms. The degree of alkoxylation of the alcohols is as a rule between 1 and 20, by preference between 3 and 10. They can be manufactured, in known fashion, by reacting the corresponding alcohols with the corresponding alkylene oxides. The derivatives of the fatty alcohols are particularly suitable, although their branched-chain isomers, in particular so-called oxo alcohols, can also be used to manufacture usable alkoxylates. The alkoxylates, in particular the ethoxylates, of primary alcohols having linear, in particular dodecyl, tetradecyl, hexadecyl, or octadecyl radicals, and mixtures thereof, are accordingly usable. Also usable are corresponding alkoxylation products of alkylamines, vicinal diols, and carboxylic acid amides that correspond to the aforesaid alcohols in terms of the alkyl portion. Additionally suitable are the ethylene-oxide and/or propylene-oxide insertion products of fatty acid alkyl esters that can be manufactured according to the method indicated in International Patent Application WO 90/13533, as well as fatty acid polyhydroxyamides that can be manufactured according to the methods of U.S. Pat. No. 1,985,424, U.S. Pat. No. 2,016,962, and U.S. Pat. No. 2,703,798, and International Patent Application WO 92/06984. So-called alkylpolyglycosides suitable for incorporation into the detergents according to the present invention are compounds of the general formula (G)ₙ—OR¹², in which R¹² denotes an alkyl or alkenyl radical having 8 to 22 carbon atoms, G denotes a glycose unit, and n denotes a number between 1 and 10. Such compounds and their manufacture are described, for example, in European Patent Applications EP 92 355, EP 301 298, EP 357 969, and EP 362 671, or U.S. Pat. No. 3,547,828. The glycoside component (G)ₙ refers to oligomers or polymers from naturally occurring aldose or ketose monomers, among which are included, in particular, glucose, mannose, fructose, galactose, talose, gulose, altrose, allose, idose, ribose, arabinose, xylose, and lyxose. The oligomers made up of glycosidically linked monomers of this kind are characterized not only by the nature of the sugars contained in them but also by their number (the so-called degree of oligomerization). The degree of oligomerization n, constituting a magnitude to be ascertained analytically, generally assumes fractional numerical values; its value is between 1 and 10, below 1.5 for the glycosides used by preference, in particular between 1.2 and 1.4. Because of its good availability, glucose is a preferred monomer module. The alkyl or alkenyl portion R¹² of the glycosides preferably derives likewise from easily accessible derivatives of renewable raw materials, in particular from fatty alcohols, although their branched-chain isomers, in particular so-called oxo alcohols, can also be used for the manufacture of usable glycosides. The primary alcohols having linear octyl, decyl, dodecyl, tetradecyl, hexadecyl, or octadecyl radicals, and mixtures thereof, are accordingly usable. Particularly preferred alkylglycosides contain a coconut oil alkyl radical, i.e. mixtures with substantially R¹²=dodecyl and R¹²=tetradecyl.

Nonionic surfactant is contained in detergents that contain a soil-release active substance used according to the present invention, are used according to the present invention, or are utilized in the method according to the present invention, by preference in quantities from 1 wt % to 30 wt %, in particular from 1 wt % to 25 wt %; quantities in the upper part of this range are more likely to be encountered in liquid laundry detergents, and particulate laundry detergents preferably contain rather smaller quantities of up to 5 wt %.

The detergents can, instead or additionally, contain further surfactants, by preference synthetic anionic surfactants of the sulfate or sulfonate type, such as e.g. alkylbenzenesulfonates, in quantities by preference not above 20 wt %, in particular from 0.1 wt % to 18 wt %, based in each case on the entire detergent. Synthetic anionic surfactants that may be mentioned as particularly suitable for use in such detergents are the alkyl and/or alkenyl sulfates, having 8 to 22 carbon atoms, which carry an alkali-, ammonium-, or alkyl- or hydroxyalkyl-substituted ammonium ion as counter-cation. The derivatives of the fatty alcohols having, in particular, 12 to 18 carbon atoms, and their branched-chain analogs (the so-called oxo alcohols), are preferred. The alkyl and alkenyl sulfates can be manufactured in known fashion by reacting the corresponding alcohol component with a usual sulfating reagent, in particular sulfur trioxide or chlorosulfonic acid, and subsequent neutralization with alkali-, ammonium-, or alkyl- or hydroxyalkyl-substituted ammonium bases. Also included among the usable surfactants of the sulfate type are the sulfated alkoxylation products of the aforesaid alcohols (so-called ether sulfates). Such ether sulfates contain by preference 2 to 30, in particular 4 to 10 ethylene glycol groups per molecule. Included among the suitable anionic surfactants of the sulfonate type are the α-sulfo esters obtainable by reacting fatty acid esters with sulfur trioxide and subsequent neutralization, in particular the sulfonation products deriving from fatty acids having 8 to 22 carbon atoms, by preference 12 to 18 carbon atoms, and linear alcohols having 1 to 6 carbon atoms, by preference 1 to 4 carbon atoms, and the sulfofatty acids proceeding therefrom by formal saponification.

Further optional surfactant ingredients that are appropriate are soaps; saturated fatty acid soaps such as the salts of lauric acid, myristic acid, palmitic acid, or stearic acid, as well as soaps derived from natural fatty acid mixtures, for example coconut, palm-kernel, or tallow fatty acids, are suitable. Those soap mixtures that are made up of 50 wt % to 100 wt % saturated C₁₂ to C₁₈ fatty acid soaps and up to 50 wt % oleic acid soap are particularly preferred. Soap is contained by preference in quantities from 0.1 wt % to 5 wt %. Greater quantities of soap, as a rule up to 20 wt %, can, however, also be contained in particular in liquid detergents that contain a polymer used according to the present invention.

If desired, the detergents can also contain betaines and/or cationic surfactants, which are used (if present) by preference in quantities from 0.5 wt % to 7 wt %. Among these, the esterquats (discussed below) are particularly preferred.

In a further embodiment, the detergent contains water-soluble and/or water-insoluble builders, selected in particular from alkali aluminosilicate, crystalline alkali silicate having a modulus above 1, monomeric polycarboxylate, polymeric polycarboxylate, and mixtures thereof, in particular in quantities in the range from 2.5 wt % to 60 wt %.

The detergent contains by preference 20 wt % to 55 wt % water-soluble and/or water-insoluble organic and/or inorganic builders. Included among the water-soluble organic builder substances are, in particular, those from the class of the polycarboxylic acids, in particular citric acid and sugar acids, as well as the polymeric (poly)carboxylic acids, in particular the polycarboxylates, accessible by oxidation of polysaccharides, of International Patent Application WO 93/16110, polymeric acrylic acids, methacrylic acids, maleic acids, and mixed polymers thereof, which can also contain small proportions of polymerizable substances, without carboxylic acid functionality, polymerized in. The relative molecular weight of the homopolymers of unsaturated carboxylic acids is generally between 5000 and 200,000, that of the copolymers between 2000 and 200,000, by preference 50,000 to 120,000, based on free acid. A particularly preferred acrylic acid/maleic acid copolymer has a relative molecular weight from 50,000 to 100,000. Suitable, although less preferred, compounds of this class are copolymers of acrylic acid or methacrylic acid with vinyl ethers such as vinylmethyl ethers, vinyl esters, ethylene, propylene, and styrene, in which the proportion of acid is at least 50 wt %. Terpolymers that contain as monomers two carboxylic acids and/or salts thereof, and vinyl alcohol and/or a vinyl alcohol derivative or a carbohydrate as a third monomer, can also be used as water-soluble organic builder substances. The first acid monomer or salt thereof is derived from a monoethylenically unsaturated C₃ to C₈ carboxylic acid and by preference from a C₃ to C₄ monocarboxylic acid, in particular from (meth)acrylic acid. The second acid monomer or salt thereof can be a derivative of a C₄ to C₈ dicarboxylic acid, maleic acid being particularly preferred. The third monomeric unit is constituted in this case by vinyl alcohol and/or preferably an esterified vinyl alcohol. Vinyl alcohol derivatives that represent an ester of short-chain carboxylic acids, for example of C₁ to C₄ carboxylic acids, with vinyl alcohol, are particularly preferred. Preferred terpolymers contain 60 wt % to 95 wt %, in particular 70 wt % to 90 wt %, (meth)acrylic acid or (meth)acrylate, particularly preferably acrylic acid or acrylate, and maleic acid or maleinate, as well as 5 wt % to 40 wt %, by preference 10 wt % to 30 wt % vinyl alcohol and/or vinyl acetate. Very particularly preferred in this context are terpolymers in which the weight ratio of (meth)acrylic acid or (meth)acrylate to maleic acid or maleate is between 1:1 and 4:1, by preference between 2:1 and 3:1 and in particular 2:1 and 2.5:1. Both the quantities and weight ratios are based on the acids. The second acid monomer or salt thereof can also be a derivative of an allylsulfonic acid that is substituted in the 2-position with an alkyl radical, by preference with a C₁ to C₄ alkyl radical, or with an aromatic radical that is preferably derived from benzene or benzene derivatives. Preferred terpolymers contain 40 wt % to 60 wt %, in particular 45 to 55 wt %, (meth)acrylic acid or (meth)acrylate, particularly preferably acrylic acid or acrylate, 10 wt % to 30 wt %, by preference 15 wt % to 25 wt % methallylsulfonic acid or methallylsulfonate, and as a third monomer 15 wt % to 40 wt %, by preference 20 wt % to 40 wt % of a carbohydrate. This carbohydrate can be, for example, a mono-, di-, oligo-, or polysaccharide, mono-, di-, or oligosaccharides being preferred; sucrose is particularly preferred. The use of the third monomer is presumed to incorporate into the polymer defined break points that are responsible for the polymer's good biodegradability. These terpolymers can be manufactured in particular in accordance with methods that are described in German Patent DE 42 21 381 and German Patent Application DE 43 00 772, and generally have a relative molecular weight between 1000 and 200,000, by preference between 200 and 50,000, and in particular between 3000 and 10,000. Especially for the manufacture of liquid detergents, they can be used in the form of aqueous solutions, by preference in the form of 30- to 50-weight-percent aqueous solutions. All the aforesaid polycarboxylic acids are used as a rule in the form of their water-soluble salts, in particular their alkali salts.

Organic builder substances of this kind are contained by preference in quantities of up to 40 wt %, particularly up to 25 wt %, and particularly preferably from 1 wt % to 5 wt %. Quantities close to the aforesaid upper limit are used by preference in pasty or liquid, in particular water-containing, detergents.

Crystalline or amorphous alkali aluminosilicates are used in particular as water-insoluble, water-dispersible inorganic builder materials, in quantities of up to 50 wt %, by preference not above 40 wt %, and in liquid detergents in particular from 1 wt % to 5 wt %. Among these, the crystalline aluminosilicates of laundry-detergent quality, in particular zeolite NaA and if applicable NaX, are preferred. Quantities close to the aforesaid upper limit are used by preference in solid, particulate detergents. Suitable aluminosilicates comprise, in particular, no particles having a particle size above 30 mm, and by preference comprise at least 80 wt % of particles having a size below 10 mm. Their calcium binding ability, which can be determined according to the indications of German Patent DE 24 12 837, is in the range from 100 to 200 mg CaO per gram. Suitable substitutes or partial substitutes for the aforesaid aluminosilicates are crystalline alkali silicates, which can be present alone or mixed with amorphous silicates. The alkali silicates usable in the detergents as detergency builders have by preference a molar ratio of alkali oxide to SiO₂ below 0.95, in particular from 1:1.1 to 1:12, and can be present in amorphous or crystalline fashion. Preferred alkali silicates are the sodium silicates, in particular the amorphous sodium silicates, having a Na₂O:SiO₂ molar ratio from 1:2 to 1:2.8. Amorphous alkali silicates of this kind are obtainable commercially, for example, under the name Portil®. Those having a Na₂O:SiO₂ molar ratio from 1:1.9 to 1:2.8 can be manufactured according to the method of European Patent Application EP 0 425 427. They are added in the context of manufacture preferably as a solid, and not in the form of a solution. Crystalline sheet silicates of the general formula Na₂SiₓO₂ₓ₊₁.yH₂O, in which x, the so-called modulus, is a number from 1.9 to 4 and y is a number from 0 to 20, and preferred values for x are 2, 3, or 4, are preferred for use as crystalline silicates, which can be present alone or mixed with amorphous silicates. Crystalline sheet silicates that conform to this general formula are described, for example, in European Patent Application EP 0 164 514. Preferred crystalline sheet silicates are those in which x in the aforesaid general formula assumes the values 2 or 3. In particular, both β- and δ-sodium disilicates (Na₂Si₂O₅.yH₂O) are particularly preferred; α-sodium disilicate can be obtained, for example, according to the method described in International Patent Application WO 91/08171. δ-Sodium silicates having a modulus between 1.9 and 3.2 can be manufactured in accordance with Japanese Patent Applications JP 04/238 809 or JP 04/260 610. Practically anhydrous crystalline alkali silicates manufactured from amorphous alkali silicates and having the aforesaid general formula, in which x denotes a number from 1.9 to 2.1, producible as described in European Patent Applications EP 0 548 599, EP 0 502 325, and EP 0 425 428, can also be used in detergents that contain a polymer according to the present invention. In a further preferred embodiment of detergents according to the present invention, a crystalline sodium sheet silicate having a modulus from 2 to 3 is used, which silicate can be manufactured from sand and soda according to the method of European Patent Application EP 0 436 835. Crystalline sodium silicates having a modulus in the range from 1.9 to 3.5, as obtainable according to the method of European Patents EP 0 164 552 and/or European Patent Application EP 0 294 753, are used in a further preferred embodiment of laundry detergents that contain a cellulose derivative used according to the present invention. Their alkali silicate content is by preference 1 wt % to 50 wt %, and in particular 5 wt % to 35 wt %, based on anhydrous active substance. If alkali aluminosilicate, in particular zeolite, is also present as an additional builder substance, the alkali silicate content is by preference 1 wt % to 15 wt %, and in particular 2 wt % to 8 wt %, based on anhydrous active substance. The weight ratio of aluminosilicate to silicate, based in each case on anhydrous active substances, is then by preference 4:1 to 10:1. In detergents that contain both amorphous and crystalline alkali silicates, the weight ratio of amorphous alkali silicate to crystallie alkali silicate is by preference 1:2 to 2:1, and in particular 1:1 to 2:1.

In addition to the aforesaid inorganic builders, further water-soluble or water-insoluble inorganic substances can be contained in the detergents that contain a cellulose derivative to be used according to the present invention, are used together therewith, or are utilized in methods according to the present invention. The alkali carbonates, alkali hydrogencarbonates, and alkali sulfates, and mixtures thereof, are suitable in this context. Additional inorganic material of this kind can be present in quantities of up to 70 wt %.

In addition, the detergents can contain further constituents that are usual in laundry detergents and cleaning agents. Included among these optional constituents are, in particular, enzymes, enzyme stabilizers, complexing agents for heavy metals, for example aminopolycarboxylic acids, aminohydroxypolycarboxylic acids, polyphosphonic acids, and/or aminopolyphosphonic acids, foam inhibitors, for example organopolysiloxanes or paraffins, solvents, and optical brighteners, for example stilbenedisulfonic acid derivatives. By preference, up to 1 wt %, in particular 0.01 wt % to 0.5 wt %, optical brighteners, in particular compounds from the class of the substituted 4,4′-bis(2,4,6-triamino-s-triazinyl)stilbene-2,2′-disulfonic acids, up to 5 wt %, in particular 0.1 wt % to 2 wt % complexing agents for heavy metals, in particular aminoalkylenephosphonic acids and salts thereof, and up to 2 wt %, in particular 0.1 wt % to 1 wt % foam inhibitors, are contained in detergents that contain a cellulose derivative used according to the present invention, the aforesaid weight proportions referring in each case to the entire detergent.

Solvents, which can be used in particular with liquid detergents, are (in addition to water) preferably those that are miscible with water. Included among these are the lower alcohols, for example ethanol, propanol, isopropanol, and the isomeric butanols, glycerol, lower glycols, for example ethylene glycol and propylene glycol, and the ethers derivable from the aforesaid classes of compounds. In such liquid detergents, the cellulose derivatives used according to the present invention are generally present in dissolved or suspended form.

Enzymes that may be present are by preference selected from the group encompassing protease, amylase, lipase, cellulase, hemicellulase, oxidase, peroxidase, or mixtures thereof. Protease, recovered from microorganisms such as bacteria or fungi, is especially suitable. It can be recovered in known fashion from suitable microorganisms by fermentation processes, which are described for example in German Applications DE 19 40 488, DE 20 44 161, DE 21 01 803, and DE 21 21 397, U.S. Pat. No. 3,623,957 and U.S. Pat. No. 4,264,738, European Patent Application EP 006 638, and International Patent Application WO 91/02792. Proteases are obtainable commercially, for example, under the names BLAP®, Savinase®, Esperase®, Maxatase®, Optimase®, Alcalase®, Durazym®, or Maxapem®. The lipases that are usable can be recovered from Humicola lanuginosa as described e.g. in European Patent Applications EP 258 068, EP 305 216, and EP 341 947, from Bacillus species as described e.g. in International Patent Application WO 91/16422 or European Patent Application EP 384 717, from Pseudomonas species as described e.g. in European Patent Applications EP 468 102, EP 385 401, EP 375 102, EP 334 462, EP 331 376, EP 330 641, EP 214 761, EP 218 272, or EP 204 284 or International Patent Application WO 90/10695, from Fusarium species as described e.g. in European Patent Application EP 130 064, from Rhizopus species as described e.g. in European Patent Application EP 117 553, or from Aspergillus species as described e.g. in European Patent Application EP 167 309. Suitable lipases are obtainable commercially, for example, under the names Lipolase®, Lipozym®, Lipomax®, Lipex®, Amano® Lipase, Toyo-Jozo® Lipase, Meito® Lipase, and Diosynth® Lipase. Suitable amylases are commercially available, for example, under the names Maxamyl®, Termamyl®, Duramyl®, and Purafect® OxAm. The cellulase that is usable can be an enzyme recoverable from bacteria or fungi, which exhibits a pH optimum preferably in the weakly acid to weakly alkaline range from 6 to 9.5. Cellulases of this kind are known, for example, from German Applications DE 31 17 250, DE 32 07 825, DE 32 07 847, DE 33 22 950, or European Patent Applications EP 265 832, EP 269 977, EP 270 974, EP 273 125, and EP 339 550, and from International Patent Applications WO 95/02675 and WO 97/14804, and are commercially available under the names Celluzyme®, Carezyme®, and Ecostone®.

Included among the usual enzyme stabilizers present if applicable, in particular in liquid detergents, are aminoalcohols, for example mono-, di-, triethanol- and -propanolamine and mixtures thereof, lower carboxylic acids as known, for example, from European Patent Applications EP 376 705 and EP 378 261, boric acid or alkali borates, boric acid/carboxylic acid combinations as known, for example, from European Patent Application EP 451 921, boric acid esters as known, for example, from International Patent Application WO 93/11215 or European Patent Application EP 511 456, boronic acid derivatives as known, for example, from European Patent Application EP 583 536, calcium salts, for example the calcium/formic acid combination known from European Patent EP 28 865, magnesium salts as known, for example, from European Patent Application EP 378 262, and/or sulfur-containing reducing agents as known, for example, from European Patent Applications EP 080 748 or EP 080 223.

Included among the suitable foam inhibitors are long-chain soaps, in particular behenic soap, fatty acid amides, paraffins, waxes, microcrystalline waxes, organopolysiloxanes, and mixtures thereof, which can furthermore contain microfine, optionally silanized or otherwise hydrophobized silicic acid. For use in particulate detergents, foam inhibitors of this kind are preferably bound to granular, water-soluble carrier substances as described, for example, in German Application DE 34 36 194, European Patent Applications EP 262 588, EP 301 414, EP 309 931, or European Patent EP 150 386.

In a preferred embodiment, a detergent into which cellulose derivative to be used according to the present invention is incorporated is particulate, and contains up to 25 wt %, in particular 5 wt % to 20 wt % bleaching agent, in particular alkali percarbonate, up to 15 wt %, in particular 1 wt % to 10 wt % bleach activator, 20 wt % to 55 wt % inorganic builders, up to 10 wt %, in particular 2 wt % to 8 wt % water-soluble organic builders, 10 wt % to 25 wt % synthetic anionic surfactant, 1 wt % to 5 wt % nonionic surfactant, and up to 25 wt %, in particular 0.1 wt % to 25 wt % inorganic salts, in particular alkali carbonate and/or alkali hydrogencarbonate.

In a further preferred embodiment, a detergent into which cellulose derivative to be used according to the present invention is incorporated is liquid, and contains 10 wt % to 25 wt %, in particular 12 wt % to 22.5 wt % nonionic surfactant, 2 wt % to 10 wt %, in particular 2.5 wt % to 8 wt % synthetic anionic surfactant, 3 wt % to 15 wt %, in particular 4.5 wt % to 12.5 wt % soap, 0.5 wt % to 5 wt %, in particular 1 wt % to 4 wt % organic builders, in particular polycarboxylate such as citrate, up to 1.5 wt %, in particular 0.1 wt % to 1 wt % complexing agents for heavy metals, such as phosphonate, and in addition to an optionally contained enzyme, enzyme stabilizer, dye and/or fragrance, water and/or water-miscible solvent.

Also possible is the use of a combination of the aforesaid cotton-active soil-release-enabling cellulose derivative with a polyester-active soil-release-enabling polymer made up of a dicarboxylic acid and an optionally polymeric diol, to intensify the cleaning performance of bleaching-agent-containing laundry detergents when washing textiles. Such combinations of an aforesaid cotton-active soil-release-enabling cellulose derivative with a polyester-active soil-release-enabling polymer are also possible in the context of detergents according to the present invention and of the method according to the present invention.

Included among the soil-release-enabling polymers known to be polyester-active that can be used in addition to the cellulose derivatives essential to the invention are copolyesters of dicarboxylic acids, for example adipic acid, phthalic acid, or terephthalic acid, diols, for example ethylene glycol or propylene glycol, and polydiols, for example polyethylene glycol or polypropylene glycol. Included among the soil-release-enabling polyesters preferred for use are those compounds that are accessible formally by the esterification of two monomer parts, the first monomer being a dicarboxylic acid HOOC-Ph-COOH and the second monomer being a diol HO—(CHR¹¹—)ₐOH, which can also be present as a polymeric diol H—(O—(CHR¹¹—)ₐ)_{b}OH, in which Ph denotes an o-, m-, or p-phenylene radical that can carry 1 to 4 substituents selected from alkyl radicals having 1 to 22 carbon atoms, sulfonic acid groups, carboxyl groups, and mixtures thereof, R¹¹ denotes hydrogen, an alkyl radical having 1 to 22 carbon atoms, and mixtures thereof, a is a number from 2 to 6, and b is a number from 1 to 300. By preference, both monomer diol units —O—(CHR¹¹—)ₐ)_{b}O— and polymer diol units —(O—(CHR¹¹—)ₐ)_{b}O— are present in the polyesters obtainable therefrom. The molar ratio of monomer diol units to polymer diol units is by preference 100:1 to 1:100, in particular 10:1 to 1:10. In the polymer diol units, the degree of polymerization b is preferably in the range from 4 to 200, in particular from 12 to 140. The molecular weight or average molecular weight, or the maximum of the molecular weight distribution, of preferred soil-release-enabling polyesters is in the range from 250 to 100,000, in particular from 500 to 50,000. The acid on which the Ph radical is based is selected by preference from terephthalic acid, isophthalic acid, phthalic acid, trimellitic acid, mellitic acid, the isomers of sulfophthalic acid, sulfoisophthalic acid, and sulfoterephthalic acid, and mixtures thereof. If their acid groups are not part of the ester bonds in the polymer, they are preferably present in salt form, in particular as an alkali or ammonium salt. Among these, the sodium and potassium salts are particularly preferred. If desired, instead of the HOOC-Ph-COOH monomer, small proportions—in particular no more than 10 mol % based on the proportion of Ph having the meaning indicated above—of other acids that comprise at least two carboxyl groups can be contained in the soil-release-enabling polyester. Included among these are, for example, alkylene and alkenylene dicarboxylic acids such as malonic acid, succinic acid, fumaric acid, maleic acid, glutaric acid, adipic acid, pimelic acid, suberic acid, azelaic acid, and sebacic acid. Included among the preferred diols HO—(CHR¹¹—)ₐOH are those in which R¹¹ is hydrogen and a is a number from 2 to 6, and those in which a has the value of 2 and R¹¹ is selected from hydrogen and the alkyl radicals having 1 to 10, in particular 1 to 3, carbon atoms. Among the last-named diols, those of the formula HO—CH₂—CHR¹¹—OH, in which R¹¹ has the meaning indicated above, are particularly preferred. Examples of diol components are ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol, and neopentyl glycol. Polyethylene glycol having an average molar weight in the range from 1000 to 6000 is particularly preferred among the polymeric diols.

If desired, the polyesters having the composition as described above can also be end-capped, alkyl groups having 1 to 22 carbon atoms and esters of monocarboxylic acids being suitable as terminal groups. The terminal groups, bound via ester bonds, can be based on alkyl, alkenyl, and aryl monocarboxylic acids having 5 to 32 carbon atoms, in particular 5 to 18 carbon atoms. Included among these are valeric acid, hexanoic acid, oenanthic acid, octanoic acid, pelargonic acid, decanoic acid, undecanoic acid, undecenoic acid, lauric acid, lauroleic acid, tridecanoic acid, myristic acid, myristoleic acid, pentadecanoic acid, palmitic acid, stearic acid, petroselic acid, petroselaidic acid, oleic acid, linoleic acid, linolaidic acid, linolenic acid, eleostearic acid, arachidic acid, gadoleic acid, arachidonic acid, behenic acid, erucic acid, brassidic acid, clupanodonic acid, lignoceric acid, cerotic acid, melissic acid, benzoic acid, that can carry 1 to 5 substituents having a total of up to 25 carbon atoms, in particular 1 to 12 carbon atoms, for example tert.-butylbenzoic acid. The terminal groups can also be based on hydroxymonocarboxylic acids having 5 to 22 carbon atoms, included among which are, for example, hydroxyvaleric acid, hydroxyhexanoic acid, ricinoleic acid, its hydrogenation product hydroxystearic acid, and o-, m-, and p-hydroxybenzoic acid. The hydroxymonocarboxylic acids can in turn be connected to one another via their hydroxyl group and their carboxyl group, and thus be present more than once in a terminal group. By preference, the number of hydroxymonocarboxylic acid units per terminal group, i.e. their degree of oligomerization, is in the range from 1 to 50, in particular from 1 to 10. In a preferred embodiment of the invention, polymers of ethylene terephthalate and polyethylene oxide terephthalate, in which the polyethylene glycol units have molecular weights from 750 to 5000 and the molar ratio of ethylene terephthalate to polyethylene oxide terephthalate is 50:50 to 90:10, are used in combination with the cellulose derivatives.

The soil-release-enabling polymers are preferably water-soluble; the term “water-soluble” is to be understood as a solubility of at least 0.01 g, by preference at least 0.1 g, of the polymer per liter of water at room temperature and pH 8. Polymers preferred for use exhibit under these conditions, however, a solubility of at least 1 g per liter, in particular at least 10 g per liter.

Preferred laundry post-treatment agents that contain a cellulose derivative to be used according to the present invention comprise as a laundry-softening active substance a so-called esterquat, i.e. a quaternized ester of carboxylic acid and aminoalcohol. These are known substances that can be obtained in accordance with the relevant methods of preparative organic chemistry. In connection therewith, reference may be made to International Patent Application WO 91/01295, according to which triethanolamine is partially esterified with fatty acids in the presence of hypophosphoric acid, air is passed through, and quaternization then occurs using dimethyl sulfate or ethylene oxide. German Patent DE 43 08 794 moreover makes known a method for manufacturing solid esterquats, in which method the quaternization of triethanolamine esters is carried out in the presence of suitable dispersants, by preference fatty alcohols. Reviews of this topic have appeared, for example by R. Puchta et al. in Tens.Surf.Det, 30, 186 (1993), by M. Brock in Tens.Surf.Det. 30, 394 (1993), by R. Lagerman et al. in J.Am.Oil.Chem.Soc, 71, 97 (1994), and by 1. Shapiro in Cosm.Toil. 109, 77 (1994).

Esterquats preferred in the detergents are quaternized fatty acid triethanolamine ester salts that conform to formula (I):

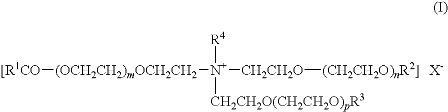

in which R¹CO denotes an acyl radical having 6 to 22 carbon atoms, R² and R³, mutually independently, denote hydrogen or R¹CO, R⁴ denotes an alkyl radical having 1 to 4 carbon atoms or a (CH₂CH₂O)_{q}H group, m, n, and p in total denote 0 or numbers from 1 to 12, q denotes numbers from 1 to 12, and X denotes a charge-equalizing anion such as a halide, alkyl sulfate, or alkyl phosphate. Typical examples of esterquats that can be used in the context of the invention are products based on hexanoic acid, octanoic acid, decanoic acid, lauric acid, myristic acid, palmitic acid, isostearic acid, stearic acid, oleic acid, elaidic acid, arachidic acid, behenic acid, and erucic acid, and technical mixtures thereof, such as those occurring upon high-pressure cleavage of natural fats and oils. By preference, technical C_{12/18} coconut oil fatty acids, and in particular partially hardened C_{16/18} tallow or palm oil fatty acids, as well as elaidic-acid-rich C_{16/18} fatty acid cuts, are used. For manufacture of the quaternized esters, as a rule the fatty acids and the triethanolamine can be used at a molar ratio from 1.1:1 to 3:1. With regard to the applications-engineering properties of the esterquats, a utilization ratio from 1.2:1 to 2.2:1, by preference 1.5:1 to 1.9:1, has proven particularly advantageous. The esterquats preferred for use represent technical mixtures of mono-, di-, and triesters having an average degree of esterification from 1.5 to 1.9, and are derived from technical C_{16/18} tallow or palm fatty acid (iodine number 0 to 40). Quaternized fatty acid triethanolamine ester salts of formula (I) in which R¹CO denotes an acyl radical having 16 to 18 carbon atoms, R² denotes R¹CO, R³ denotes hydrogen, R⁴ denotes a methyl group, m, n, and p denote 0, and X denotes methyl sulfate, have proven particularly advantageous.

Also suitable as esterquats, in addition to the quaternized carboxylic acid triethanolamine ester salts, are quaternized ester salts of carboxylic acids with diethanolalkylamines, of formula (II):

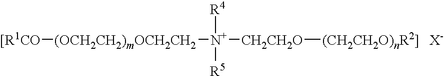

in which R¹CO denotes an acyl radical having 6 to 22 carbon atoms, R² denotes hydrogen or R¹CO, R⁴ and R⁵, mutually independently, denote alkyl radicals having 1 to 4 carbon atoms, m and n in total denote 0 or numbers from 1 to 12, and X denotes a charge-equalizing anion such as halide, alkyl sulfate, or alkyl phosphate.

Lastly, a further group of suitable esterquats that may be mentioned are the quaternized ester salts of carboxylic acids with 1,2-dihydroxypropyldialkylamines, of formula (III):

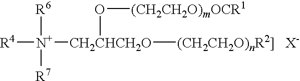

in which R¹CO denotes an acyl radical having 6 to 22 carbon atoms, R² denotes hydrogen or R¹CO, R⁴, R⁶, and R⁷, mutually independent, denote alkyl radicals having 1 to 4 carbon atoms, m and n in total denote 0 or numbers from 1 to 12, and X denotes a charge-equalizing anion such as halide, alkyl sulfate, or alkyl phosphate.

With regard to selection of the preferred fatty acids and of the optimum degree of esterification, the indications given by way of example for (I) also apply analogously to the esterquats of formulas (II) and (III). The esterquats are usually brought to market in the form of 50- to 90-weight-percent alcohol solutions, which can also be diluted with water without difficulty; ethanol, propanol, and isopropanol are the usual alcohol solvents.

Esterquats are used by preference in quantities from 5 wt % to 25 wt %, in particular 8 wt % to 20 wt %, based in each case on the entire laundry post-treatment agent. If desired, the laundry post-treatment agents used according to the present invention can additionally contain the laundry detergent ingredients referred to above, provided they do not interact in unreasonably negative fashion with the esterquat. The agent is preferably liquid and water-containing.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred. Description of constituents in chemical terms refers unless otherwise indicated, to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed.

Changes in form and substitution of equivalents are contemplated as circumstances may suggest or render expedient. Although specific terms have been employed herein, such terms are intended in a descriptive sense and not for purposes of limitation. The invention is illustrated in more detail by means of the following examples.

### EXAMPLES

### Example 1

By simple mixing of the constituents, a liquid laundry detergent (V1) containing

| | |
|---|---|
| ABS | 10 wt % |
| FAEOS | 5 wt % |
| C_{12/14} 7 EO | 10 wt % |
| C_{12/18} fatty acid | 5 wt % |
| Glycerol | 5 wt % |
| Sodium citrate | 3 wt % |
| Protease/amylase/cellulase | 1 wt % |
| Tinopal ® DMS-X ^{a)} | 0.2 wt % |
| water | to make 100 wt % |

^{a)} optical brightener, manufactured by Ciba

was manufactured, as were laundry detergents that were of otherwise identical composition and that, with a reduction in the quantity of water, contained 1 wt % methylcarboxypropyl cellulose having an average degree of methylation of 1.90 and an average degree of carboxyalkylation of 0.01 (W1), 1 wt % methylcarboxyethyl cellulose having an average degree of methylation of 1.90 and an average degree of carboxyalkylation of 0.09 (W2), or 1 wt % methylcarboxyethyl cellulose having an average degree of methylation of 1.56 and an average degree of carboxyalkylation of 0.03 (W2). The cellulose ethers used were obtained by reacting cellulose with chloromethane and then with the corresponding chloroalkanecarboxylic acid; their molecular weights were 78,000 D. Cotton fabrics were treated as follows:

| Washing machine | Miele W 918 Novotronic ® |
|---|---|
| Primary washing action: | Single-bath process, normal cycle |
| Washing temperature: | 40° C. |
| Bath volume: | 15 l |
| Water hardness: | 16° dH |
| Laundry load: | 3.5 kg clean laundry |
| No. of determinations: | 3 |

The unstained fabrics were washed three times, under the conditions indicated above, with each of the laundry detergents to be tested, and dried after each wash. After the three pre-washes, the fabrics were stained by hand with the following standardized stains:

0.10 g lipstick
0.10 g black shoe polish

The stained fabrics were then measured with a Minolta® CR 200 and then aged for 7 days at room temperature. The stained fabrics were then tacked onto handkerchiefs and washed under the conditions indicated above.

The fabrics were dried, and measured again using a Minolta CR 200. The following washing results (dde values) were obtained:

TABLE 1

| | Lipstick | Black shoe polish |
|---|---|---|
| V1 | 65.1 | 51.0 |
| W1 | 77.6 | 57.6 |
| W2 | 77.4 | 57.2 |
| W3 | 72.9 | 54.2 |

It is evident that the laundry detergents having the cellulose derivative to be used according to the present invention (W1, W2, and W3) exhibit much better washing performance than the detergent that does not contain it (V1).

### Example 2

Washing experiments were performed as described in Example 1; this time, a particulate laundry detergent V2 containing

| | |
|---|---|
| ABS | 11 wt % |
| C_{13/15} 7 EO | 3 wt % |
| Sodium carbonate | 20 wt % |
| Sodium hydrogencarbonate | 5 wt % |
| Sodium sulfate | 25 wt % |
| Sodium silicate | 5 wt % |
| Sodium percarbonate | 13 wt % |
| TAED | 5 wt % |
| Sodium polyacrylate | 4.5 wt % |
| Enzyme ^{a)} | 3.5 wt % |
| water | to make 100 wt % |

^{a)} granular combination of protease, amylase, and cellulase

was used, as were laundry detergents that were of otherwise identical composition and that, with a reduction in the quantity of sodium sulfate, contained 1 wt % methycarboxypropyl cellulose having an average degree of methylation of 1.90 and an average degree of carboxyalkylation of 0.01 (W4), wt % methylcarboxyethyl cellulose having an average degree of methylation of 1.90 and an average degree of carboxyalkylation of 0.09 (W5), or 1 wt % methylcarboxyethyl cellulose having an average degree of methylation of 1.56 and an average degree of carboxyalkylation of 0.03 (W6). The following washing results (dde values) were obtained:

TABLE 2

| | Lipstick | Black shoe polish |
|---|---|---|
| V2 | 59.4 | 46.9 |
| W4 | 74.2 | 54.4 |
| W5 | 75.0 | 52.3 |
| W6 | 75.4 | 52.7 |

It is evident here as well that the laundry detergents having the cellulose derivative to be used according to the present invention (W4, W5, and W6) exhibit much better washing performance than the detergent that does not contain it (V2).

What is claimed:

1. A method of laundering, comprising contacting a textile comprising cotton and having a stain in need of removal with an effective amount of a laundry detergent comprising a soil-release-enabling cellulose derivative obtained by alkylating and carboxyalkylating a cellulose comprising an anhydroglycose monomer unit, wherein the cellulose derivative comprises on average 0.4 to 2.7 alkyl groups and 0.001 to 0.3 carboxyalkyl groups per anhydroglycose monomer unit.

2. The method of claim 1, wherein the textile comprising cotton has previously been laundered or post-treated with the cellulose derivative before acquiring the stain.

3. The method of claim 1, wherein the laundry detergent further comprises a polyester-active soil-release-enabling polymer comprising the reaction product of a dicarboxylic acid and an optionally polymeric diol.

4. The method of claim 1, wherein the alkyl groups comprise C₁ to C₁₀ groups and the carboxyalkyl groups comprise C₁ to C₁₀ carboxyalkyl groups.

5. The method of claim 4, wherein the alkyl groups comprise C₁ to C₃ alkyl groups and the carboxyalkyl groups comprise C₁ to C₄ carboxyalkyl groups.

6. The method of claim 1, wherein the cellulose derivative comprises on average 0.5 to 2.5 alkyl groups and 0.002 to 0.2 carboxyalkyl groups per anhydroglycose monomer unit.

7. The method of claim 6, wherein the cellulose derivative comprises on average 1 to 2 alkyl groups and 0.005 to 0.1 carboxyalkyl groups per monomer unit.

8. The method of claim 1, wherein the cellulose derivative has an average molar weight of 10,000 D to 150,000 D.

9. The method of claim 8, wherein the cellulose derivative has an average molecular weight of 40,000 D to 120,000 D.

10. The method of claim 9, wherein the cellulose derivative has an average molecular weight of 70,000 D to 110,000 D.

11. The method of claim 1, wherein the laundry detergent comprises 5% to 70% by weight of a peroxygen-based bleaching agent and, optionally, 2% to 10% by weight of a bleach activator.

12. A method of washing a textile comprising cotton, comprising contacting a textile comprising cotton with a laundry detergent and a soil-release-enabling cellulose derivative, the cellulose derivative obtained by alkylating and carboxyalkylating a cellulose comprising an anhydroglycose monomer unit, wherein the cellulose derivative comprises on average 0.4 to 2.7 alkyl groups and 0.001 to 0.3 carboxyalkyl groups per anhydroglycose monomer unit.

13. The method of claim 12, comprising contacting the textile in a washing operation with the detergent, the detergent optionally comprising a bleach, and post-treating the washed textile with a post-treatment agent comprising the cellulose derivative.

14. The method of claim 13, wherein the post-treatment agent further comprises an esterquat.

15. The method of claim 14, wherein the post-treatment agent comprises from 5% to 25% by weight of the esterquat.

16. The method of claim 15, wherein the post-treatment agent comprises 8% to 20% by weight of the esterquat.

17. The method of claim 12, wherein the post-treatment agent comprises 0.1% to 2% by weight of the cellulose derivative.

18. The method of claim 17, wherein the post-treatment agent comprises 0.5% to 1% by weight of the cellulose derivative.

19. A laundry detergent comprising a soil-release-enabling cellulose derivative, said derivative comprising an alkylated and carboxyalkyled cellulose comprising an anhydroglycose monomer unit and on average 0.4 to 2.7 alkyl groups and 0.001 to 0.3 carboxyalkyl groups per anhydroglycose monomer unit.
